(19) United States
(12) Patent Application Publication
(10) Pub. No.: US 2014/0152402 A1
(43) Pub. Date: Jun. 5, 2014

(54) COMMON MODE NOISE CHIP FILTER AND METHOD FOR PREPARING THEREOF

(71) Applicant: SAMSUNG ELECTRO-MECHANICS CO., LTD., Gyeonggi-do (KR)

(72) Inventors: Sang Moon LEE, Gyeonggi-do (KR); Jun Hee BAE, Gyeonggi-do (KR); Sung Kwon WI, Gyeonggi-do (KR); Yong Suk KIM, Gyeonggi-do (KR)

(73) Assignee: SAMSUNG ELECTRO-MECHANICS CO., LTD., Gyeonggi-do (KR)

(21) Appl. No.: 13/843,717

(22) Filed: Mar. 15, 2013

(30) Foreign Application Priority Data
Dec. 4, 2012 (KR) 10-2012-0139728

(51) Int. Cl. H03H 7/01

(52) U.S. Cl. CPC H03H 7/0138; H03H 3/00
USPC 333/185; 29/600

(57) ABSTRACT

Disclosed herein are a common mode noise chip filter and a method for preparing thereof, the common mode noise chip filter including: a ferrite substrate; coil patterns formed on the ferrite substrate; and a ferrite-polymer composite layer on the substrate provided with the coil patterns, wherein the ferrite-polymer composite layer includes spherical ferrite particles and flake shaped ferrite particles.

### CROSS REFERENCE(S) TO RELATED APPLICATIONS

This application claims the benefit under 35 U.S.C. Section 119 of Korean Patent Application Serial No. 10-2012-0139728, entitled “Common Mode Noise Chip Filter and Method for Preparing Thereof” filed on Dec. 4, 2012, which is hereby incorporated by reference in its entirety into this application.

### BACKGROUND OF THE INVENTION

1. Technical Field

The present invention relates to a common mode noise chip filter and a method for preparing thereof.

2. Description of the Related Art

Electronic devices around us generate more or less radiation noise. Since noise freely and suddenly changes, noise immunity allowing an electronic device itself not to generate noise and preventing an electronic device from malfunctioning by external noise has been required. This is the basis of electro magnetic compatibility (EMC).

Generally, conduction noise may ‘be bypassed’ to a ground by a condenser, or ‘be absorbed’ by a resistor and a ferrite core, a chip bead, or the like, to thereby be converted into heat and then removed.

As a measure against conduction noise, there is another important method. That is a method of “reflecting” noise current using a property of an inductor. The inductor allows a direct current to easily flow, but allows an alternate current not to easily flow due to increased impedance (resistance for the alternate current). However, as a transferring type of conduction noise, there are two types; a differential mode type and a common mode type. Therefore, a measure against noise according to a type of noise is required. If the type of noise is not identified, even though a noise suppression component is added to a circuit, the noise may further increase.

The common mode is a conduction mode in which the noise transfers in the same direction with respect to an outward path and a return path. The common mode noise may be generated by impedance unbalance of a wiring system. In addition, the higher a frequency is, the more significant the common mode noise is. In addition, since the common mode noise is also transferred to the ground, or the like, to return while drawing a large loop, various noise disturbances may be generated even in a distant electronic device.

Therefore, in a digital device, a measure against the common mode noise is regarded as important as or more important than a measure against the differential mode noise.

A common mode noise filter has a structure in which an insulation layer 12 is formed on a ferrite substrate 11, a resist insulation layer 14 for forming internal coil conductors 13 is formed thereon, the coil conductors 13 are connected to via electrodes (not shown), and then the coil conductors 13 are connected to an external electrode 16 by a lead out wire 15 at an outer peripheral surface of the substrate 11 as shown in FIG. 1.

In addition, an inner portion of the coil conductor 12 is provided with an opening part (not shown) penetrating through the insulation layer 14, and the opening part is filled with a ferrite-polymer composite layer 18.

A structure of FIG. 1 viewed from above is shown in FIG. 2.

The ferrite-polymer composite layer 18 is made of a ferrite composite formed by mixing a ferrite powder with a polymer binder, wherein the ferrite uses one kind of powder or two kinds of powders having different sizes.

In addition, in order to improve a permeability value, a method of increasing a particle size of the ferrite, a method of decreasing an amount of polymer binder, or a method of raising a temperature at the time of molding, or the like, is used. However, when the particle size is increased, high frequency characteristics are deteriorated, and when the amount of polymer binder is decreased, insulation and withstanding voltage characteristics of a green compact may be deteriorated. Further, the method of raising a temperature may cause deterioration in workability, high cost of the equipment, and a problem in reliability of a filter.

### RELATED ART DOCUMENT

### Patent Document

(Patent Document 1) Japanese Patent Laid-Open Publication No. 2010-283289

### SUMMARY OF THE INVENTION

A shape of a ferrite powder used in order to increase permeability may be largely divided into two shapes, that is, a spherical shape and a flake shape. Generally, among them, a spherical ferrite powder has excellent dispersibility, and a flake shaped ferrite powder has excellent adhesive force with a polymer matrix.

An object of the present invention is to provide a common mode noise chip filter including a ferrite-polymer composite layer having excellent dispersibility and adhesive force by mixing the spherical ferrite powder and the flake shaped ferrite powder.

In addition, another object of the present invention is to provide a method for preparing a common mode noise chip filter having the above-mentioned properties.

According to an exemplary embodiment of the present invention, there is provided a common mode noise chip filter including: a ferrite substrate; coil patterns formed on the ferrite substrate; and a ferrite-polymer composite layer on the substrate provided with the coil patterns, wherein the ferrite-polymer composite layer includes spherical ferrite particles and flake shaped ferrite particles.

The spherical ferrite particle and the flake shaped ferrite particle may be included at a weight ratio of 1:10 to 10:1.

The spherical ferrite particle may include at least two kinds of particles having different sizes.

The flake shaped ferrite particle may include at least two kinds of particles having different sizes.

The ferrite particle may have an average particle size of 10 to 50 μm.

The ferrite particle may be made of a Ni—Zn—Cu based material.

A polymer of the ferrite-polymer composite layer may be at least one kind selected from a group consisting of an epoxy resin, a polyimide resin, a polyamide resin, and a polyaniline resin.

The ferrite and a polymer of the ferrite-polymer composite layer may be mixed at a weight ratio of 7:1 to 10:1.

According to another exemplary embodiment of the present invention, there is provided a method for preparing a common mode noise chip filter, the method including: a first step of forming coil patterns on a ferrite substrate; and a second step of filling a ferrite-polymer mixed dispersion in the ferrite substrate provided with the coil patterns to form a ferrite-polymer composite layer, wherein in the ferrite-polymer composite layer, spherical ferrite particles and flake shaped ferrite particles are mixed and used.

The spherical ferrite particle and the flake shaped ferrite particle may be included at a weight ratio of 1:10 to 10:1.

The spherical ferrite particle may include at least two kinds of particles having different sizes.

The flake shaped ferrite particle may include at least two kinds of particles having different sizes.

The ferrite particle may have an average particle size of 10 to 50 μm.

The ferrite particle may be made of a Ni—Zn—Cu based material.

A polymer of the ferrite-polymer composite layer may be at least one kind selected from a group consisting of an epoxy resin, a polyimide resin, a polyamide resin, and a polyaniline resin.

The ferrite and a polymer of the ferrite-polymer composite layer may be mixed at a weight ratio of 7:1 to 10:1.

### BRIEF DESCRIPTION OF THE DRAWINGS

FIG. 1 is a view showing a cross-sectional structure of a common mode noise chip filter according to the related art;

FIG. 2 is a view showing a structure of the common mode noise chip filter of FIG. 1 when being viewed from above;

FIG. 3 is a view showing a cross-sectional structure of a common mode noise chip filter including a ferrite-polymer composite layer according to the exemplary embodiment of the present invention; and

FIG. 4 is a view showing a method of measuring dispersibility of a ferrite particle in ferrite-polymer composite layer prepared according to the Example and the Comparative Example.

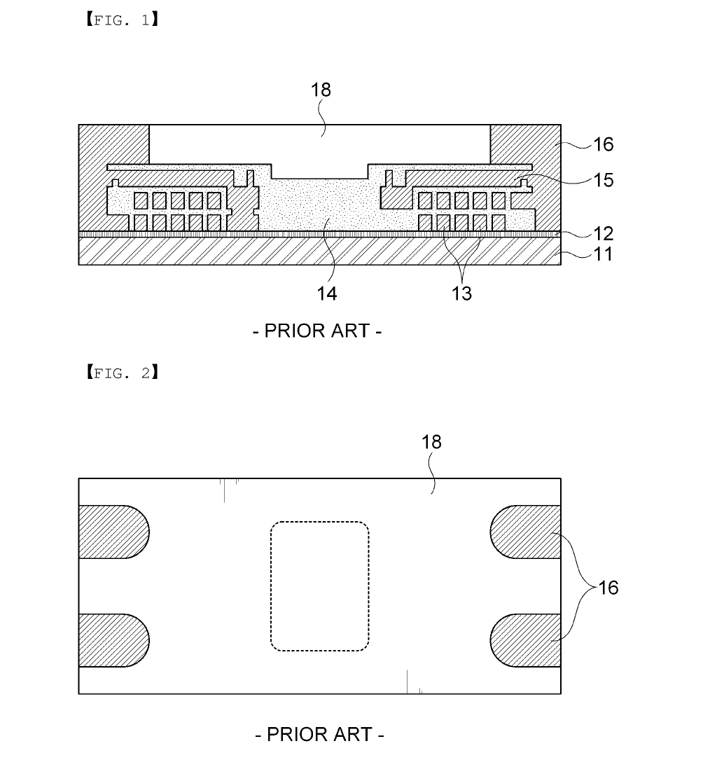

### DESCRIPTION OF THE PREFERRED EMBODIMENTS

Hereinafter, the present invention will be described in more detail with respect to the accompanying drawings.

Terms used in the present specification are used in order to describe specific exemplary embodiments rather than limiting the present invention. Unless explicitly described to the contrary, a singular form includes a plural form in the present specification. Terms “comprise” and variations such as “comprise” and/or “comprising” used in the present specification will imply the existence of stated shapes, numbers, steps, operations, elements, and/or groups thereof, but does not include the exclusion of any other shapes, numbers, steps, operations, elements, and/or groups thereof.

The present invention relates to a common mode noise chip filter and a method for preparing thereof.

In the common mode noise chip filter according to the exemplary embodiment of the present invention, a ferrite powder included in a ferrite-polymer composite layer has two shapes, such that a synergy effect may be obtained due to advantages of each of the powders.

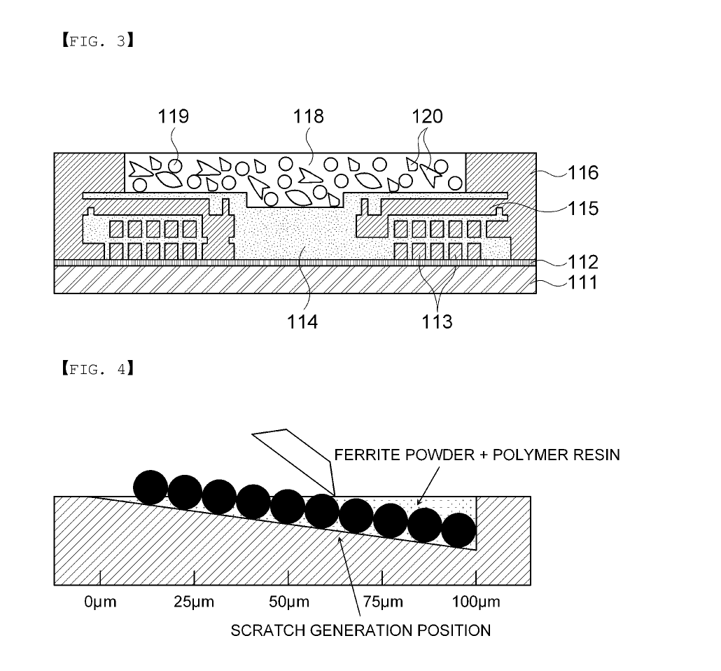

Referring to FIG. 3 showing a structure of the common mode noise chip filter according to the exemplary embodiment of the present invention, the common mode noise chip filter is configured to include a ferrite substrate 111, a coil pattern 113 formed on the ferrite substrate 111, and a ferrite-polymer composite layer 118 on the substrate 111 provided with the coil pattern 113, wherein the ferrite-polymer composite layer 118 includes spherical ferrite particles 119 and flake shaped ferrite particles 120.

That is, generally, in the case in which the spherical ferrite particle is mixed with a resin, the spherical ferrite particle is significantly advantageous for dispersion. On the contrary, since the flake shaped ferrite powder has a low dispersibility but has excellent adhesive force with a polymer resin, a phenomenon that a crack is easily generated when physical or electrical impact is applied may be reduced.

Therefore, in the present invention, it is preferable that a mixture obtained by mixing the ferrite powders having two different particle shapes mixed with each other with the polymer resin is included as the ferrite-polymer composite layer in the common mode noise chip filter.

The spherical ferrite particle and the flake shape ferrite particle may be included at a mixing weight ratio of 1:10 to 10:1. In the case in which the mixing weight ratio is out of the above-mentioned range, the dispersibility of the ferrite particles or adhesive force with a polymer matrix may be reduced.

In addition, each of the spherical ferrite particle and the flake shape ferrite particle may include at least two kinds of particles having different sizes. In this case, an average particle size of the used ferrite particles may be 10 to 50 μm. When the average particle size is less than 10 μm, dispersibility and permeability may be reduce, and when the average particle size is more than 50 μm, there is a problem in a process of injection of the particle into a cavity.

Within the average particle size range of the ferrite particle, at least two kinds of spherical ferrite particles may be mixed, or at least two kinds of flake shaped ferrite particles may be mixed. In addition, the mixed spherical ferrite particles and flake shaped ferrite particles may be mixed with each other at the mixing weight ratio as described above, and the mixture may be included in the ferrite-polymer composite layer according to the present invention.

The ferrite particle according to the exemplary embodiment of the present invention may be Ni—Zn—Cu based material. In addition, selectively, the ferrite particle may further include at least one kind selected from a group consisting of Co, Bi, and Ti.

The polymer of the ferrite-polymer composite layer according to the exemplary embodiment of the present invention may be at least one kind selected from a group consisting of an epoxy resin, a polyimide resin, a polyamide resin, and a polyaniline resin. Among them, the epoxy resin may be more preferable.

It is preferable in view of dispersibility and process capability that the ferrite and the polymer are mixed at a weight ratio of 7:1 to 10:1 in the ferrite-polymer composite layer.

The ferrite-polymer composite layer may additionally include a solvent and a dispersant. The solvent and the dispersant are not particularly limited. That is, any solvent and any dispersant may be used as long as they are used in a general ferrite-polymer composite layer.

As the ferrite substrate 111 used in the common mode noise chip filter according to the exemplary embodiment of the present invention, a general ferrite substrate may be used, and a material of the ferrite is not particularly limited.

A plurality of insulation layers 112 are formed on the ferrite substrate 111, and each of the insulation layers 112 includes the coil patterns 113 formed thereon. The coil patterns 113 of each of the insulation layers 112 are connected with each other by via electrodes (not shown) adjacent to each other, and in order to form the coil patterns 113, a resist insulation layer 114 is formed.

The insulation layer 112 serves to insulate the coil patterns 113 from each other and to planarize a surface in which the internal electrode coil patterns 113 are formed. As a material of the insulation layer 112, a polymer resin having excellent electrical or magnetic insulation characteristics and excellent formability, for example, an epoxy resin, a polyimide resin, or the like, may be used, but is not particularly limited thereto.

Further, the internal electrode coil patterns 113 according to the present invention may be made of copper (Cu), aluminum (Al), or the like, which have excellent conductivity and formability.

An opening part penetrating through each of the insulation layers 112 is formed at a central portion of the insulation layer 112, that is, inner portions of each of the internal electrode coils 113, and the internal electrode coils 113 formed on each of the insulation layers 112 are electrically connected to each other by the via electrodes of each of the insulation layers. In addition, each end portion of the internal electrode coils 113 is connected to external electrode terminals 116 through lead out wires 115.

A method for preparing this common mode noise chip filer according to the present invention may include a first step of forming coil patterns on a ferrite substrate, and a second step of filling a ferrite-polymer mixed dispersion in the substrate on which the coil patterns are formed to form a ferrite-polymer composite layer, wherein the ferrite-polymer composite layer includes spherical ferrite particles and flake shaped ferrite particles.

First, in the first step, internal electrode coil patterns are formed on a general ferrite substrate. In the internal electrode coil pattern, copper (Cu) or aluminum (Al) having excellent conductivity and formability may be used. As a method of forming the internal electrode coil pattern, an etching method using photolithography, an additive method (a plating method), or the like may be used, but the method is not particularly limited thereto.

In the second step, the ferrite-polymer mixed dispersion is filled in opening parts in the ferrite substrate on which the internal electrode coil patterns are formed to form the ferrite-polymer composite layer.

In this case, the ferrite-polymer mixed dispersion may be obtained by mixing the spherical ferrite particle and the flake shaped particle at a weight ratio of 1:10 to 10:1 and then dispersing the mixed powder in the polymer resin.

The ferrite particle used in this case may be a Ni—Zn—Cu Based material, and selectively, include at least one kind selected from a group consisting of Co, Bi, and Ti.

The polymer resin in which the mixed powder is disperse may be at least one kind selected from a group consisting of an epoxy resin, a polyimide resin, a polyamide resin, and a polyaniline resin. In addition, it is preferable in view of dispersibility and process capability that the ferrite powder and the polymer binder of the ferrite-polymer composite layer are mixed at a weight ratio of 7:1 to 10:1.

Further, it is preferable in view of wetting property and defoaming property that the ferrite-polymer composite layer according to the exemplary embodiment of the present invention has a thickness of 50 to 100 μm.

Furthermore, the ferrite-polymer mixed dispersion may further include a solvent and a dispersant, and kinds of solvent and dispersant are not particularly limited.

The ferrite powder and the solvent in the ferrite dispersion may be included at a weight ratio of 10:1 to 50:1, and the optimal coating effect may be obtained within the above-mentioned range.

After the ferrite-polymer composite layer is formed, each of the end portions of the internal electrode coils 113 is connected to the external electrode terminal 116 through the lead out wire 115, thereby preparing the common mode noise chip filter.

Hereinafter, Examples of the present invention will be described. The following Examples are only to exemplify the present invention, and the scope of the present invention should not be interpreted to being limited to these Examples. Further, although the following Examples exemplify the present invention using specific compounds, it is obvious to those skilled in the art that the same or similar effect may also be generated in the case of using equivalents to the specific compounds.

### Example 1

After spherical ferrite (NiZnCu ferrite) powders having an average particle size of 30 μm and spherical ferrite powders having an average particle size of 3 μm were mixed, the mixture was mixed with flake shaped ferrite (NiZnCu ferrite) powders having an average particle size of 30 μm and flake shaped ferrite powders having an average particle size of 3 WM.

The two kinds of mixed spherical ferrite powders and the two kinds of mixed flake shaped ferrite powders were mixed at a weight ratio of 1:10.

A small amount of a dispersant (2 wt %), a solvent (2 wt %), and a polymer resin (20 wt %), based on the total weight of the powder, were dispersed in the mixed ferrite powder, thereby preparing a ferrite-polymer dispersion (the ferrite powder and the polymer resin were mixed at a ratio of 9:1).

The ferrite-polymer dispersion was filled in cavities of a ferrite substrate on which copper internal electrode coil patterns were formed, thereby forming a ferrite-polymer composite layer having a thickness of 100 μm.

Outer peripheral ends of the internal electrode coils were connected to external electrode terminals through lead terminals, thereby preparing a common mode noise chip filter.

### Example 2

A common mode noise chip filter was prepared by the same method as in Example 1 except that a ferrite-polymer composite layer having a thickness of 100 μm was formed using a ferrite-polymer dispersion (the ferrite powder and the polymer resin were mixed at a ratio of 8:2) prepared by mixing the two kinds of mixed spherical ferrite powders and the two kinds of mixed flake shaped ferrite powders with each other at a weight ratio of 10:1).

### Comparative Example 1

A common mode noise chip filter was prepared by the same method as in Example 1 except that a ferrite-polymer composite layer having a thickness of 100 μm was formed by applying a mixing solution in which ferrite powder including only spherical ferrite (NiZnCu ferrite) having an average particle size of 30 μm and the polymer resin were mixed at a ratio of 9:1 with each other.

### Comparative Example 2

A common mode noise chip filter was prepared by the same method as in Example 1 except that a ferrite-polymer composite layer having a thickness of 100 μm was formed by applying a mixing solution in which ferrite powder including only flake shaped ferrite (NiZnCu ferrite) powders having an average particle size of 30 μm and the polymer resin were mixed at a ratio of 9:1 with each other.

### Experimental Example

### Test Results of Dispersibility and Adhesive Force

The dispersibility of ferrite particles in the ferrite-polymer composite layers prepared in Examples and Comparative Examples was measured by measuring a grindometer value of a position at which a scratch appears when the ferrite particles and the polymer are mixed and spread on a high precision grindometer as shown in FIG. 4.

In addition, the adhesive force between the ferrite substrate and the polymer resin was measured by applying shear stress to the ferrite substrate to which the polymer resin is adhered using a ball shear test M/C (4000-series, Dage Corp.), and specific conditions thereof were as follows.

Die shear: 100 kg

Shear speed: 100 um/sec

Test load: 98 N

Max test load: 4.9 N

Land speed: 2163.5 μm/sec

Shear Height: 0.5 μm

Over travel: 1000 μm

TABLE 1

| | Dispersibility (μm) | Adhesive force (Kg/cm²) |
|---|---|---|
| Comparative | 36 | 1332 |
| Example 1 | | |
| Comparative | 74 | 2432 |
| Example 2 | | |
| Example 1 | 51 | 2170 |
| Example 2 | 42 | 1881 |

As shown in Table 1, it may be appreciated that in the case of the ferrite-polymer composite layer including the spherical ferrite particle and the flake shaped ferrite particle as in the exemplary embodiment of the present invention, the dispersibility in the slurry was improved as compared with the case of Comparative Example 1 in which only the spherical ferrite powder was used and the case of Comparative Example 2 in which only the flake shaped ferrite powder was used.

In addition, the adhesive force between the ferrite substrate and the polymer matrix was improved. It may be appreciated that in the case of Comparative Example 2 in which only the flake shaped ferrite powder was used, the adhesive force was excellent, but the dispersibility was significantly low.

It may be confirmed from these results that in the case of the ferrite-polymer composite layer including the spherical ferrite particle and the flake shaped ferrite particle, the dispersibility and the adhesive force was simultaneously improved.

According to the present invention, the dispersibility of the ferrite particle in the ferrite-polymer composite layer may be improved and the adhesive force between the ferrite substrate and the polymer matrix may be improved by using a mixture of the spherical ferrite particle and the flake shaped ferrite particle in the ferrite-polymer composite layer of the common mode noise chip filter, such that cracks are not easily generated when physical or electrical impact is applied to the finally prepared common mode noise chip filter, thereby making it possible to improve reliability of the common mode noise chip filter.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A common mode noise chip filter comprising:
a ferrite substrate;
coil patterns formed on the ferrite substrate; and
a ferrite-polymer composite layer on the substrate provided with the coil patterns,
wherein the ferrite-polymer composite layer includes spherical ferrite particles and flake shaped ferrite particles.

2. The common mode noise chip filter according to claim 1, wherein the spherical ferrite particle and the flake shaped ferrite particle are included at a weight ratio of 1:10 to 10:1.

3. The common mode noise chip filter according to claim 1, wherein the spherical ferrite particle includes at least two kinds of particles having different sizes.

4. The common mode noise chip filter according to claim 1, wherein the flake shaped ferrite particle includes at least two kinds of particles having different sizes.

5. The common mode noise chip filter according to claim 1, wherein the ferrite particle has an average particle size of 10 to 50 μm.

6. The common mode noise chip filter according to claim 1, wherein the ferrite particle is made of a Ni—Zn—Cu based material.

7. The common mode noise chip filter according to claim 1, wherein a polymer of the ferrite-polymer composite layer is at least one kind selected from a group consisting of an epoxy resin, a polyimide resin, a polyamide resin, and a polyaniline resin.

8. The common mode noise chip filter according to claim 1, wherein the ferrite and a polymer of the ferrite-polymer composite layer are mixed at a weight ratio of 7:1 to 10:1.

9. A method for preparing a common mode noise chip filter, the method comprising:
a first step of forming coil patterns on a ferrite substrate; and
a second step of filling a ferrite-polymer mixed dispersion in the ferrite substrate provided with the coil patterns formed to form a ferrite-polymer composite layer,
wherein in the ferrite-polymer composite layer, spherical ferrite particles and flake shaped ferrite particles are mixed and used.

10. The method according to claim 9, wherein the spherical ferrite particle and the flake shaped ferrite particle are mixed at a weight ratio of 1:10 to 10:1.

11. The method according to claim 9, wherein the ferrite particle has an average particle size of 10 to 50 μm.

12. The method according to claim 9, wherein the spherical ferrite particle includes at least two kinds of particles having different sizes.

13. The method according to claim 9, wherein the flake shaped ferrite particle includes at least two kinds of particles having different sizes.

14. The method according to claim 9, wherein the ferrite particle is made of a Ni—Zn—Cu based material.

15. The method according to claim 9, wherein a polymer of the ferrite-polymer composite layer is at least one kind selected from a group consisting of an epoxy resin, a polyimide resin, a polyamide resin, and a polyaniline resin.
